(19) United States
(12) Patent Application Publication
(10) Pub. No.: US 2024/0164582 A1
(43) Pub. Date: May 23, 2024

(54) FOOD PROCESSING DEVICE ATTACHMENT RECOGNITION SYSTEMS AND METHODS

(71) Applicant: SharkNinja Operating LLC, Needham, MA (US)

(72) Inventors: Yaoming Deng, Guangdong (CN); Ted Wood, London (GB); Noah William Weinstock, Needham, MA (US); Michelle Power, London (GB); Logan Hinchcliffe, London (GB); Christopher William Hedges, London (GB)

(73) Assignee: SharkNinja Operating LLC, Needham, MA (US)

(21) Appl. No.: 17/785,715

(22) PCT Filed: Jun. 8, 2022
(86) PCT No.: PCT/CN2022/097592

§ 371 Date: Jun. 15, 2022

(51) Int. Cl. A47J 43/07; A47J 43/044; A47J 43/08

(52) U.S. Cl. CPC A47J 43/0711; A47J 43/044; A47J 43/082; A47J 2043/04418; A47J 2043/04427

(57) ABSTRACT

A food processing device includes a base housing having an attachment receiver arranged to receive a food processing attachment that is configured to perform a food processing operation. The attachment receiver includes an electrical connector having a plurality of electrical contacts. The device includes a first processor having a plurality of ports where each port of the plurality of ports is in electrical communication with each of the plurality of electrical contacts. The first processor is configured to: i) receive an identification signal at a first port of the plurality of ports via the electrical connector from a second processor in the received food processing attachment to identify the received food processing attachment, and ii) when an identification signal is not received, monitor a voltage at each of the plurality of ports to identify the received food processing attachment.

### FIELD

The subject disclosure relates to food processing devices, and more particularly, to food processing devices capable of identifying and connecting to different types of attachments.

### BACKGROUND

A wide variety of devices for food processing exist. However, each food processing device, by itself, tends to serve only a small number of food processing needs. This can be due to limitations in the mechanical layout of each device, which limits the way the device can be comfortably gripped and operated in different orientations, and for effective use in difference food processing situations. Further, food processing devices can be limited in the extent to which they allow for the attachment of different mixing, blending, whisking, or other types of food processing ends that can be attached for various purposes. This created a need for many different devices to be purchased and maintained by an individual or business to effectively attend to all food processing needs that may arrive.

Certain existing kitchen tools have been developed that allow for interchangeably connecting various types of attachments capable of performing different types of food processing functions. Typically, such kitchen tools are able to identify the type of attachment when connected to the kitchen tool. However, the number of attachments that can be identified or the ability to identify new types of attachments, and/or provide forwards compatibility to new attachments is limited. Accordingly, there is a need for a single food processing device or kitchen tool capable of more scalable, evolvable, and flexible attachment recognition and interaction.

### SUMMARY

The present disclosure addresses technical problems associated with existing food processing devices and/or kitchen tools by enabling scalable and forward-compatible attachment recognition. It should be appreciated that food processing devices are not limited to devices that are commonly referred to as “food processing devices,” but rather can include any device that performs any form of processing food, for example, by performing one or more of the foregoing: mixing, blending, pureeing, slicing, dicing, chopping, grating, shaving, peeling, grinding, squeezing, folding, kneading, other forms of processing food, or any suitable combination of the foregoing. Illustrative food processing device attachment detection, identification, and/or control systems and methods are described that enable passive and/or active attachment detection. Passive attachment detection may be enabled via one or more electrical contacts at an attachment interface of a food processing device attachment while active attachment detection may involve communications exchanged between a processor (e.g., a microprocessor, controller or programmed circuitry) of the food processing device and a processor (e.g., a microprocessor, controller or programmed circuitry) within a food processing attachment via a communication connection at the attachment interface and attachment receiver. In some implementations, a food processing device and/or kitchen tool includes both passive and active attachment detection and/or identification. In certain implementations, an attachment includes a processor and memory arranged to enable the food processing attachment to identify itself to a food processing device when the attachment is connected to the food processing device.

In one aspect, a food processing device includes a base housing having an attachment receiver arranged to receive a food processing attachment configured to perform a food processing operation. The attachment receiver includes an electrical connector having a plurality of electrical contacts. The device also includes a first processor having a plurality of ports such that each port of the plurality of ports is in electrical communication with each of the plurality of electrical contacts respectively. The first processor is configured to: i) receive an identification signal at a first port of the plurality of ports via the electrical connector from a second processor in the received food processing attachment to identify the received food processing attachment, and ii) when an identification signal is not received, monitor a voltage at each of the plurality of ports to identify the received food processing attachment.

The first processor may be configured to periodically transmit a poll signal via the electrical connector to the received food processing attachment from a second port of the plurality of ports. The identification signal may be received by the first processor via the electrical connector in response to transmitting the poll signal. The base housing may be configured to provide a power signal to the food processing attachment via the electrical connector. The base housing may be configured to provide a ground connection to the food processing attachment via the electrical connector.

The identification signal may include an identity of the type of food processing attachment. The type of attachment includes one of a blender, chopper, mixer, immersion blender, frother, vacuum sealer, pasta roller, grinder, food processor bowl, and direct prepper. The identification signal may be received via asynchronous serial communications.

The first processor may be configured to receive a motor control signal at the first port via the electrical connector from the second processor. The first processor may be configured to transmit motor status data to the second processor via the electrical connector from the second port of the plurality of ports.

In another aspect, a food processing attachment for a food processing device includes an attachment interface arranged to detachably connect to an attachment receiver in a base housing of the food processing device. The attachment interface includes an electrical connector having a plurality of electrical contacts. The food processing attachment also includes an attachment processor having a plurality of ports such that each port of the plurality of ports is in electrical communication with each of the plurality of electrical contacts respectively. The attachment processor is configured to transmit an identification signal from a first port of the plurality of ports of the attachment processor to a base processor in the base housing of the food processing device via the electrical connector when the attachment interface is connected to the attachment receiver.

The attachment processor may be configured to receive a poll signal at a second port of the plurality of ports from the base processor via the electrical connector. The attachment processor may transmit the identification signal in response to receiving the poll signal. The food processing attachment may be configured to receive a power signal from the base housing via the electrical connector. The food processing attachment may be configured to receive a ground connection from the base housing via the electrical connector.

The identification signal may include an identity of the type of food processing attachment. The identification signal may be transmitted via asynchronous serial communications. The attachment processor may be configured to transmit a motor control signal to control a motor in the base housing via the electrical connector. The attachment processor may be configured to receiver motor status data from the base processor via the electrical connector.

In a further aspect, a method for identifying a food processing attachment includes: connecting the food processing attachment to a base housing of a food processing device via an attachment receiver including an electrical connector have a plurality of electrical contacts; electrically connecting each of a plurality of ports of a first processor in the base housing with each of a plurality of electrical contacts respectively; receiving, by the first processor, an identification signal at a first port of the plurality of ports via the electrical connector from a second processor in the received food processing attachment to identify the received food processing attachment; and when an identification signal is not received, monitoring by the first processor a voltage at each of the plurality of ports to identify the received food processing attachment.

### BRIEF DESCRIPTION OF THE DRAWINGS

So that those having ordinary skill in the art to which the disclosed system pertains will more readily understand how to make and use the same, reference may be had to the following drawings.

FIG. 1 is an exploded view of a hand-held food processing device in accordance with the subject technology;

FIG. 2 is a side view of a hand-held food processing device with a mixing attachment while in use;

FIG. 3 is a side view of a hand-held food processing device with a blending attachment while in use;

FIG. 4 is a side perspective view of an isolated base handle for a food processing device;

FIG. 5 is a top view of the base handle of FIG. 4;

FIG. 6 is a close perspective bottom view of the base handle of FIG. 4;

FIG. 7a is a top perspective view of a mixing attachment for the food processing device;

FIG. 7b is a side view of the mixing attachment of FIG. 7a;

FIG. 7c is a side perspective view of the mixing attachment of FIG. 7a;

FIG. 7d is a bottom view of the mixing attachment of FIG. 7a;

FIG. 8 is a bottom perspective view of the mixing attachment of FIG. 7a with mixing ends removed;

FIG. 9 is a close perspective overhead view of the mixing attachment of FIG. 7;

FIG. 10a is a side view of a blending attachment for the food processing device;

FIG. 10b is a top view of the blending attachment of FIG. 10a;

FIG. 10c is a bottom view of the blending attachment of FIG. 10a;

FIGS. 11a-11b are side views of alternative blending attachments for the food processing device;

FIGS. 12a-12b are side views of alternative mixing end attachments for the mixing attachment of the food processing device;

FIG. 13 includes an exploded view of a food processing device with functional block diagrams associated with the device electronics;

FIG. 14 shows a block diagram of a computer system;

FIG. 15 shows a block diagram of the electrical connection between a processor in the base housing and an attachment processor that facilitates active attachment identification;

FIG. 16 shows a diagram of the electrical connections between a processor in the based housing and an attachment that facilitates passive attachment identification;

FIG. 17A includes a table correlating electrical contact configurations with an attachment;

FIG. 17B shows the attachment contact configuration of the attachments identified in the table of FIG. 17A; and

FIG. 18 includes a flow diagram of a process for detecting the connection of an attachment to a food processing device.

### DETAILED DESCRIPTION

The subject technology overcomes many of the prior art problems associated with food processing devices and/or kitchen tools by enabling scalable and forwards compatible attachment recognition. The present disclosure includes illustrative food processing device attachment detection, identification, and/or control systems and methods that enable passive and/or active attachment detection. Passive attachment detection may be enabled via one or more electrical contacts at the attachment interface while active attachment detection may involve communications exchanged between a processor of the food processing device and a processor within an attachment via a communication connection at the attachment interface. In some implementations, a food processing device and/or kitchen tool includes both passive and active attachment detection and/or identification. In some implementations, an attachment includes a processor and memory arranged to enable the attachment to identify itself to a food processing device when the attachment is connected to the food processing device.

Furthermore, the subject technology provides a food processing device which allows for the removable attachment of mixing attachment with various mixing ends and, separately, a blending attachment with a different orientation. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always at a higher elevation).

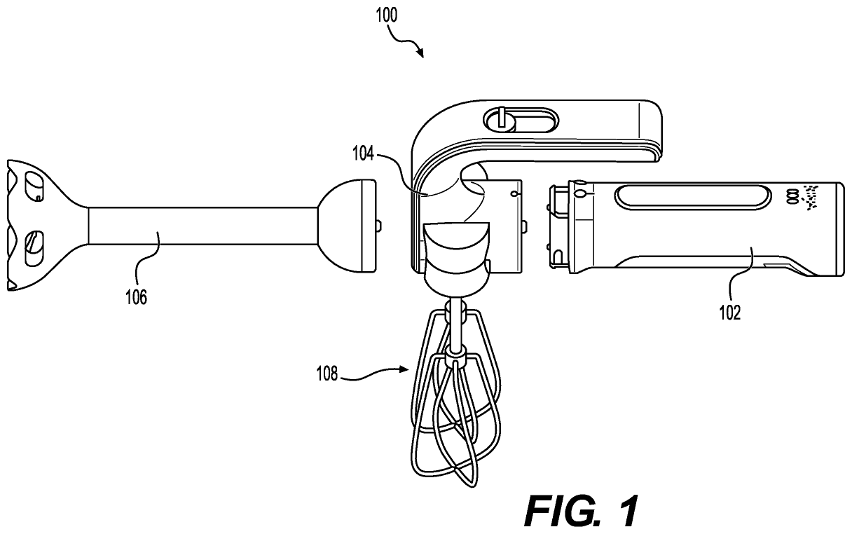

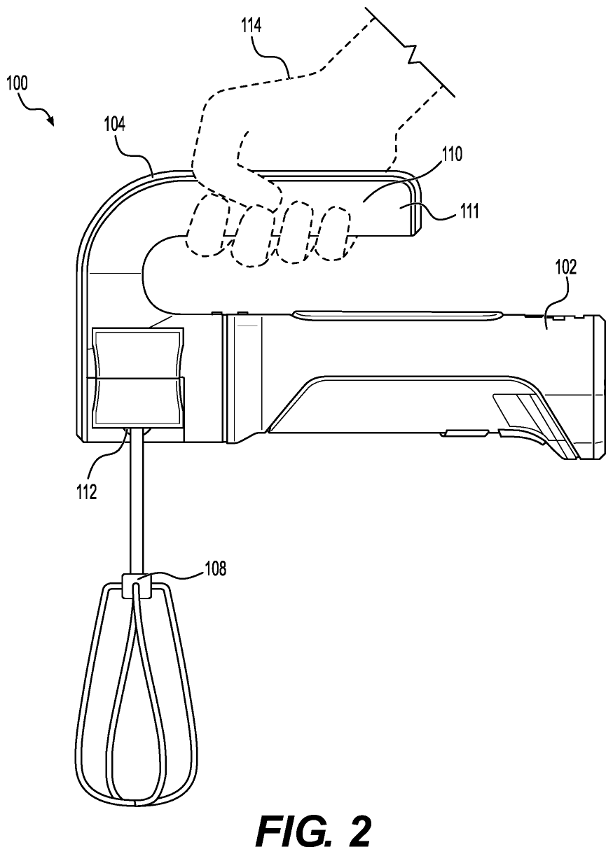

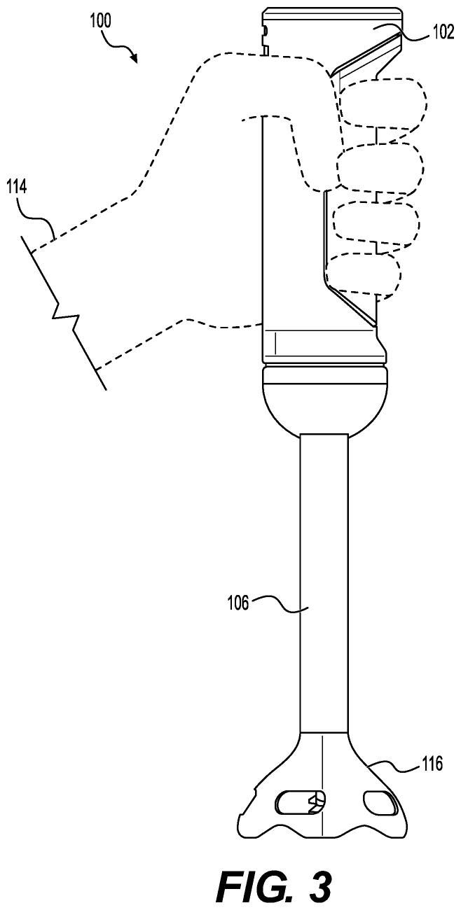

Referring now to FIGS. 1-3, a kitchen tool and/or hand-held food processing device 100 in accordance with the subject technology is shown. While an illustrative hand-held food processing device is described herein, one of ordinary skill recognizes that other types of kitchen tools and/or food processing devices may be configured to interchangeably receive, identify, and/or control multiple types of food processing attachments. FIG. 1 shows an exploded view of the hand-held food processing device 100, while FIGS. 2-3 show perspective views of the food processing device 100 while in use. The food processing device 100 generally includes a motorized base housing 102 which can be coupled to different attachments depending on a desired food processing action needed. In the example given, the base housing 102 can removably attach to either a hand mixing attachment 104 or a blending attachment 106. When attached, a motor assembly within the base housing 102 (not distinctly shown) will drive rotational movement of a mixing end 108 of the corresponding attachment. In general, the mixing attachment 104 is designed to allow for the attachment of a variety of mixing ends 108, such as a single or double beaters, whisks, or dough hooks. Further, the food process device 100 can include a variety of blending attachments 106 which can be attached for different purposes. Various types of mixing ends and blending attachments will be discussed in more detail below.

FIG. 2 shows an illustrative orientation of the food processing device 100, in use, with the mixing attachment 104 connected. The mixing attachment 104 attaches directly to the base housing 102 and includes an additional proximal handle portion 110, at a proximal end 111, which runs substantially parallel to the base housing 102 once the mixing attachment 104 has been attached to the base housing 102. The mixing attachment 104 includes a mixing end attachment portion 112, which allows for the removable attachment of a mixing end 108, as shown in FIG. 2. The mixing attachment 104 is designed such that the mixing end 108 will be held at a substantially perpendicular orientation with respect to both the base housing 102 and the handle 110 of the mixing attachment 104. As such, the user can grip the handle portion 110 of the mixing attachment 104 with one hand 114, and grip the base housing 102 with a second hand (not distinctly shown). This affords the user better control of the food processing device 100, as they are able to more easily steer the device 100 when holding the device in contact with food being processed.

FIG. 3 shows an illustrative orientation of the food processing device 100, in use, with the blending attachment 106 connected. The blending attachment 106 connects directly to the base housing 102 in a fixed orientation such that the blending attachment 106 is substantially axially aligned with the base housing 102. Therefore, the user can grip the base housing 102 from the side (e.g. as shown by hand 114) to steer the blending attachment 106.

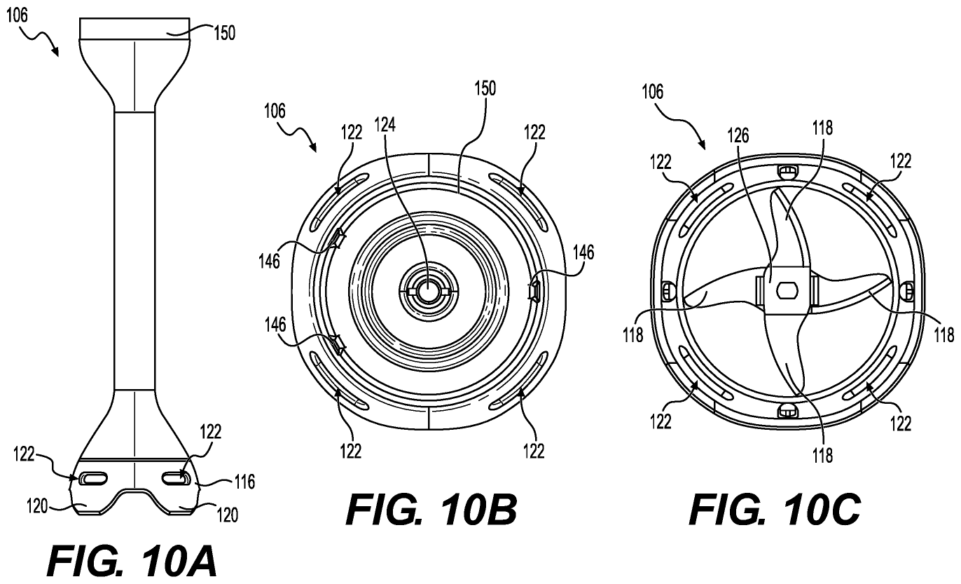

As shown in more detail in FIGS. 10a-10c, the blending attachment 106 includes a blending attachment end 116, which can include blades 118, ridges 120, grooves 122, or additional, otherwise shaped areas, to process food as desired. In use, the motor assembly will drive either the entire blending attachment end, or a portion of the blending attachment to effect rotational movement for food processing. For example, this can be accomplished by connecting a shaft 124 within the blending attachment 106, which drives the blade assembly 126, to the motor assembly of the base housing 102.

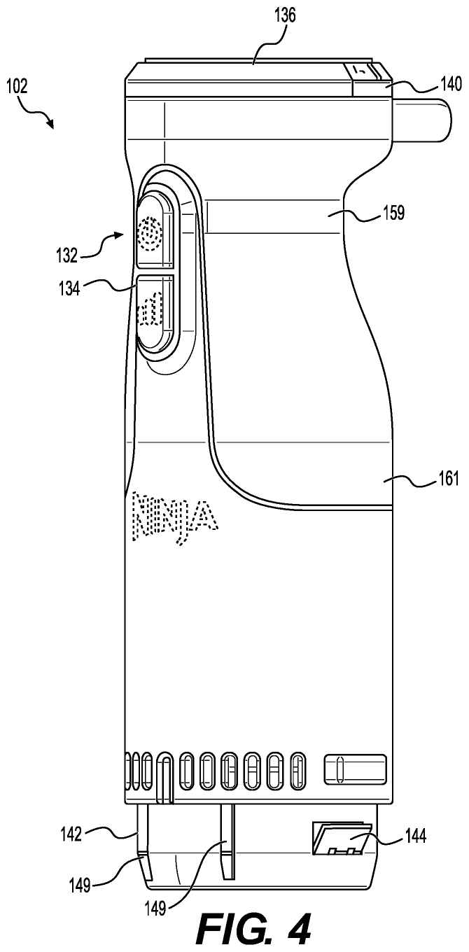

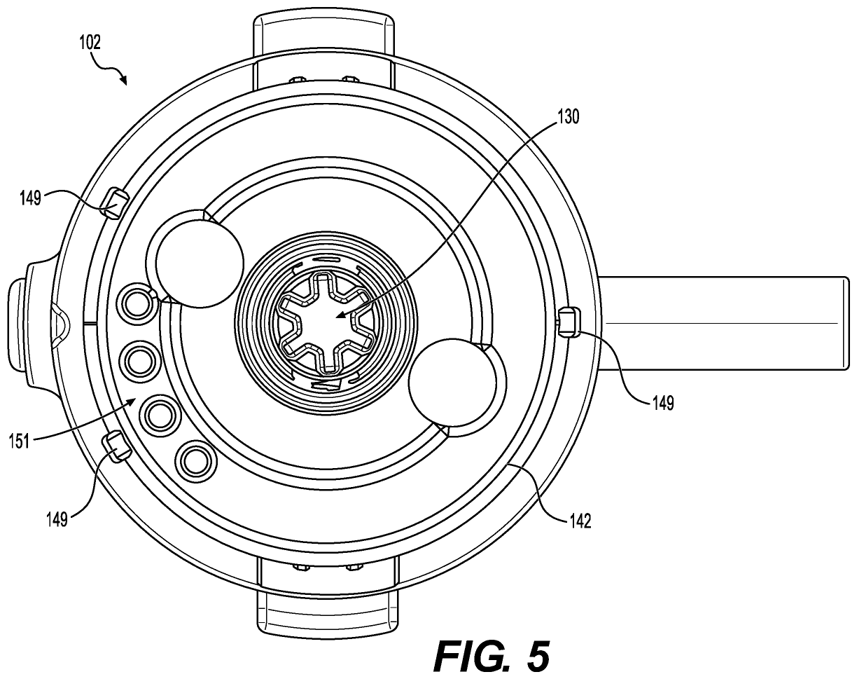

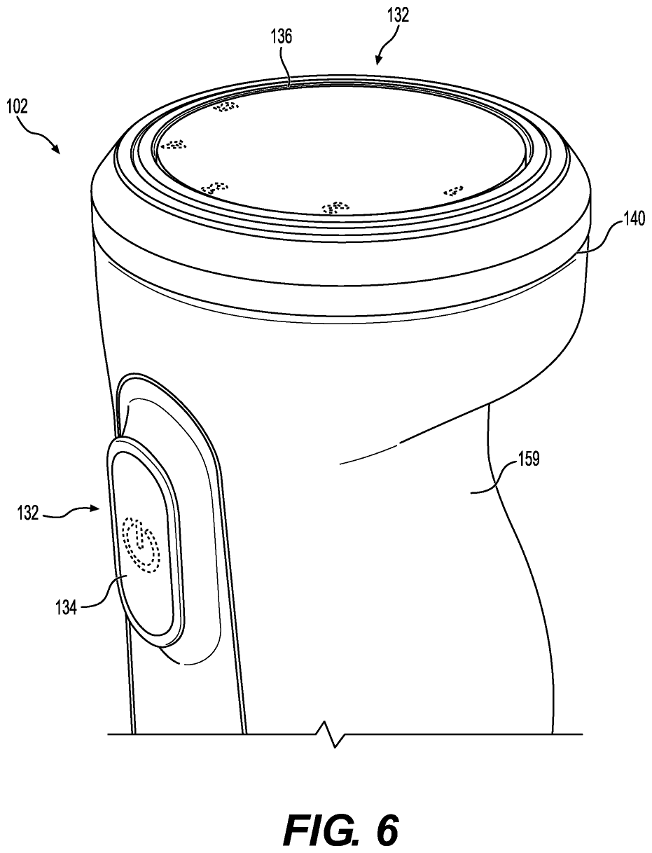

Referring now to FIGS. 4-6, the base housing 102 is shown isolated from the food processing device 100. While not distinctly shown, the base housing 102 includes a motor assembly which ultimately effectuates rotational movement within either attachment (i.e. 104, 106) for food processing. This can be accomplished by a conventional motor, as are known in the art. For example, the motor assembly can include an electric motor powered by a DC voltage from a battery or through an AC voltage from a battery within the base housing 102. Power can drive a motor shaft which can be translated into a shaft of an attached mixing or blending end 104, 106 via a drive coupler 130, gear assembly, or other mechanism within the base housing 102.

The food processing device 100 can include two different operational settings for controlling the motor. In a first operational setting, the base housing 102 controls the motor assembly. The first operational setting allows the base housing 102 to attach to and control the blending attachment 106, or other similar attachment which has no control mechanism of its own. Alternatively, as will be discussed in more detail below, when the base housing 102 connects to the mixing attachment 104, controls on the mixing attachment 104 can disable the controls of the base housing 102, allowing the food processing device 100 to operate in a second operational mode where the food processing device 100 is controlled by the user control of the mixing attachment 104.

In that regard, referring again to FIGS. 4-6, the base housing 102 includes a set of user controls 132 which allow a user to control a power setting and a variable speed of the motor assembly, in a first operational setting, to drive the blending attachment 106. In the example given, a first user input/output (I/O) 134 provides for power controls while a second I/O 136 provides for the motor speed control. The first I/O 134 is a simple push button which allows for power to be toggled, moving the food processing device 100 between an “on” and an “off” state. The second I/O 136 includes a touch sensitive pad displaying a plurality of numbers around the circumference of a proximal end 140 of the base housing 102. Each number corresponds to a speed of the motor, which in turn dictates a rotational speed of the attachment. For example, the number “1” can correspond to a slowest motor speed, while the number “5” corresponds to a fastest motor speed, with the numbers “2”, “3”, and “4” representing incrementally faster speeds from the slowest speed to the fastest speed. The I/O 136 is configured such that, once power is toggled on, the user can touch a desired speed and the motor speed will change in accordance with the selected speed. Therefore the I/O 136 allows user to both easily change a current speed of the motor and view the current speed setting.

The distal end and/or attachment receiver 142 of the base housing 102 includes the mechanism for mechanically attaching the base housing 102 to either the mixing attachment 104 or blending attachment 106, or another attachment type. In particular, the base housing 102 can include outwardly biased tabs 144 (note that while only one tab 144 is visible in FIG. 4, the base housing 102 may include a plurality of tabs 144, e.g. 2, 3, 4, or more tabs 144). The tabs 144 slope outwardly from the distal end 142 to the proximal end 140 of the base housing 102. The mixing and blending attachments 104, 106 can include corresponding attachment areas 148, 150 which include grooves designed to retain the tabs 144. The attachment area 148, 150 of the mixing attachment 104 or blending attachment 106 can slide over the distal end 142 of the base housing 102, allowing the tabs 144 to be depressed inward. Once the tabs 144 align with the grooves, the tabs are biased (e.g. through a spring or otherwise) to extend outward and into the grooves, locking in place and locking the base housing 102 to the attachment 104, 106. The base housing 102 can also include a quick release mechanism, such as a push button on the user control 132, which can be actuated to depress the tabs 144 and the release the mixing and/or blending attachment 104, 106 from the base housing 102. In this way, the base housing 102 allows for either the mixing or blending attachment 104, 106 to be quickly and effectively attached to, or removed from, the base housing 102. This allows for a speedy transition between various food processing options.

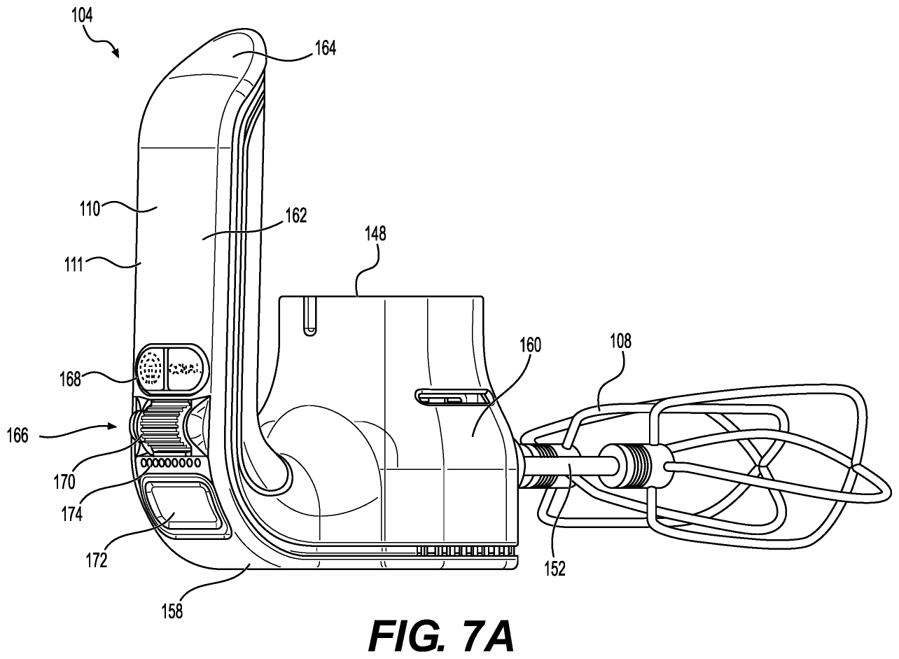

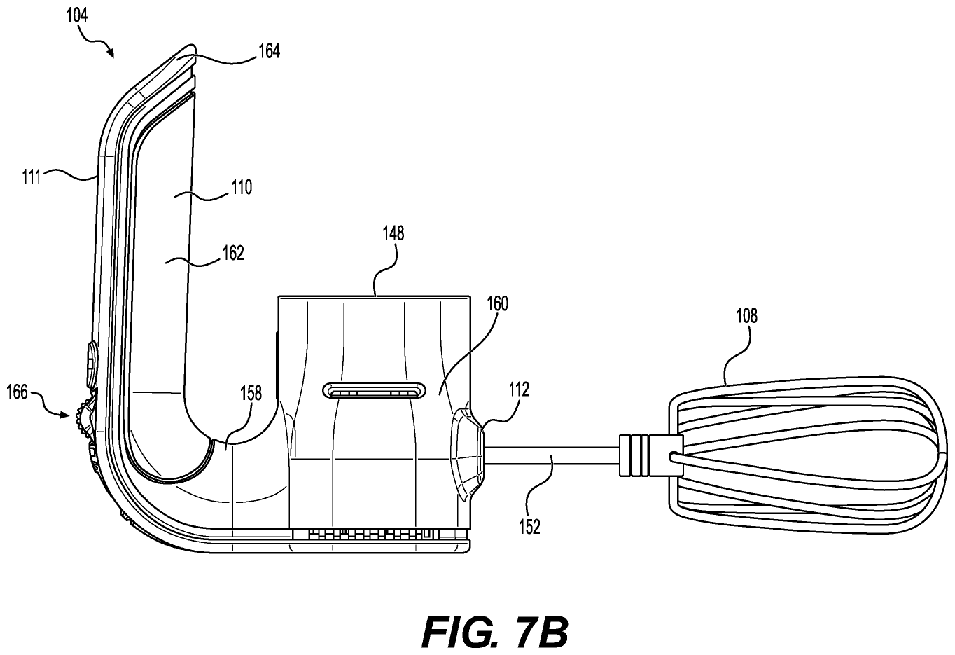

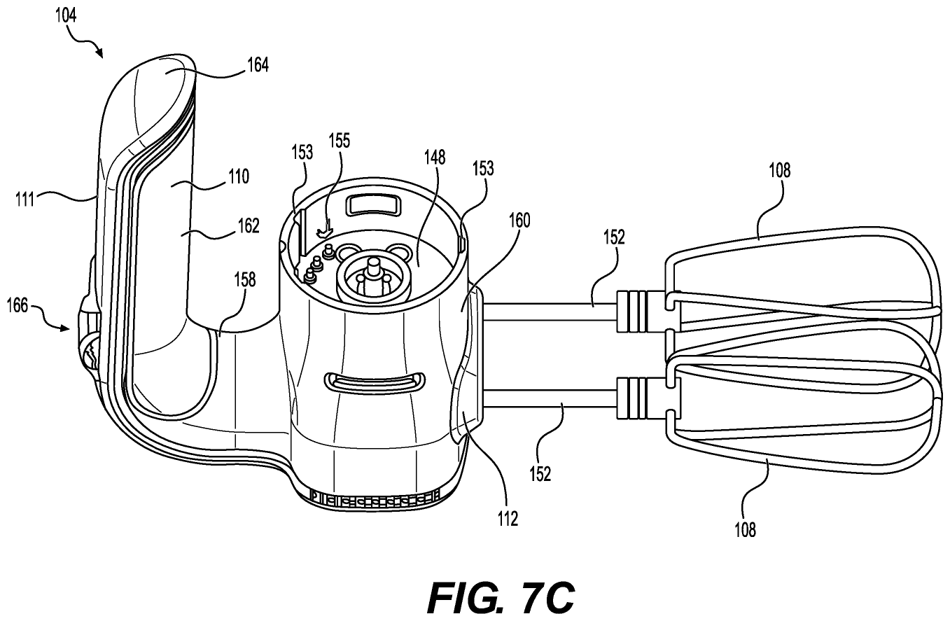

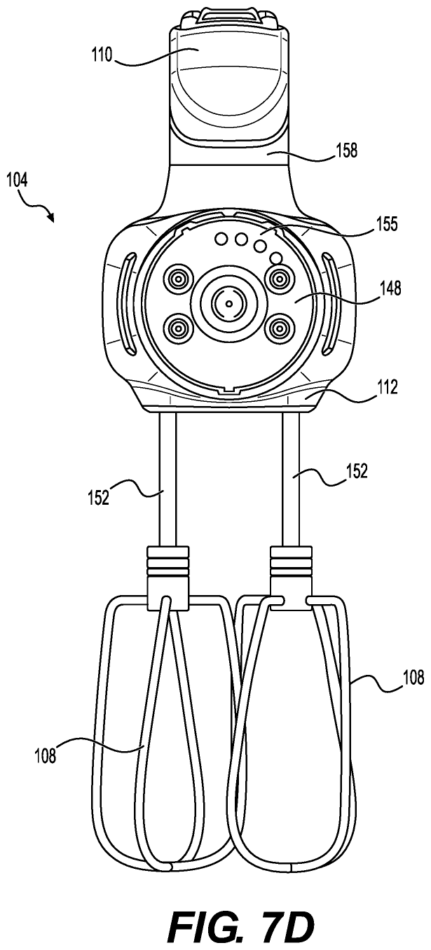

Additionally, the distal end and/or attachment receiver 142 of the base housing 102 can include ribs 149 which couple with grooves 146, 153 within the attachment area and/or attachment interface 148, 150 of the mixing attachment 104 and/or blending attachment 106 (see FIG. 7c, 10b). The ribs 149 protrude from the distal end and/or attachment receiver 142 of the base housing 102 and run axially down the length of the base housing 102. The grooves 146 are correspondingly shaped channels, allowing the grooves 146, 153 to receive the ribs 149 to guide the distal end and/or attachment receiver 142 of the base housing 102 into the corresponding attachment area and/or attachment interface 148. After the mixing attachment 104 or blending attachment 106 is attached to the base housing 102, the engagement between the ribs 149 and grooves 146, 153 also helps rotationally lock the housing of the base housing 102 to the housing of the respective attachment 104, 106. Note, while three ribs 149 and corresponding grooves 146, 153 have been found to be effective, it should be understood that other numbers can also be used, such as two, four, or six, and so on.

To facilitate easy ergonomic gripping, the base housing 102 can have a substantially cylindrical shape from the proximal end 140 through the center 161 with a depression 159 (i.e. a section of a smaller diameter than a central section 161 of the base housing 102) just before the proximal end 140. At the proximal end 140, the base handle can then include an end knob 163 which expands back to a diameter substantially the same as the center 161 of the base housing 102. This improves stability when resting the base housing 102 on its end 104 between processes, particularly when the device 100 is being used as a hand mixer (e.g. with the blending attachment 106).

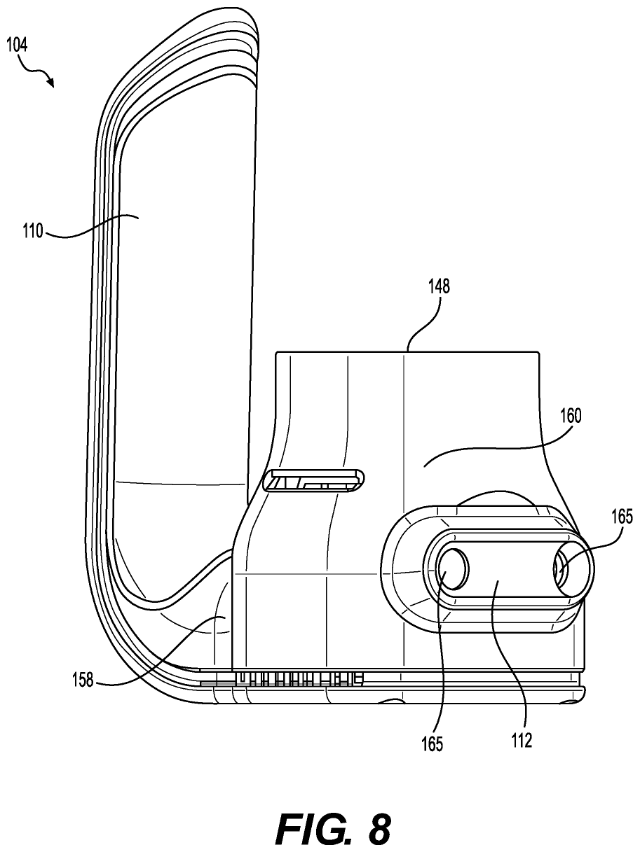

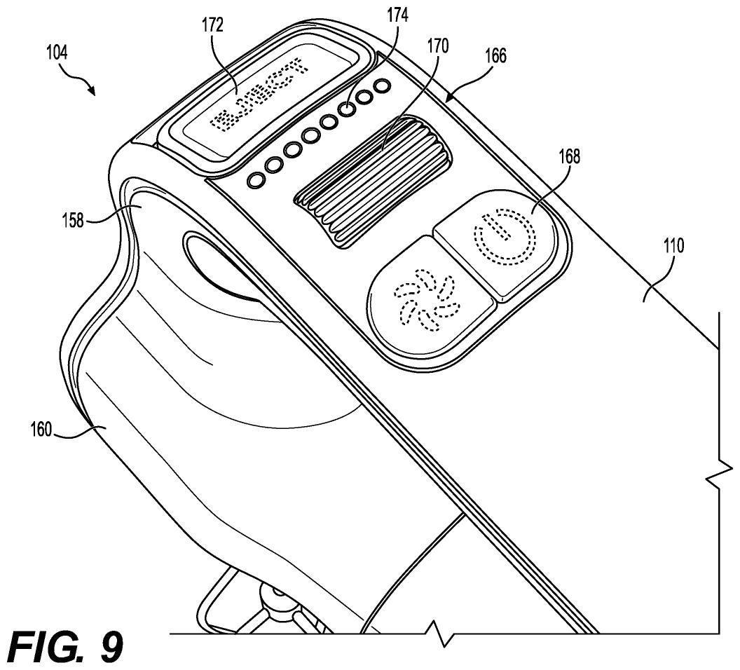

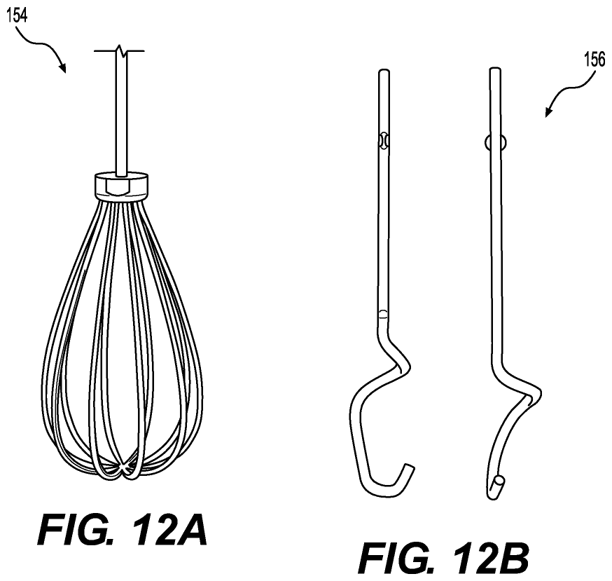

Referring now to FIGS. 7a-9, the mixing attachment 104 is shown isolated from the food processing device 100. The mixing attachment 104 includes a mixing end attachment portion 112, which can attach one or more different mixing ends which serve different purposes. In the example of FIGS. 7a-7d and 9, double whisking ends 108 are attached. Each whisking end 108 has a shaft 152 which can be inserted into an opening 165 (see FIG. 8 with whisking ends 108 omitted) in the mixing end attachment portion 112. A locking detent mechanism, or other mechanical locking mechanism, can be used to releasably connect the whisks 108 to the mixing attachment 104. When attached to the base housing 102 for use, the mixing attachment 104 holds the mixing ends 108 perpendicularly to the base housing 102 (and to a proximal handle 110 of the mixing attachment 104). Other illustrative mixing attachment ends 154, 156 are shown in FIGS. 12a, 12b and described in more detail below.

The mixing attachment 108 also includes a proximal handle 110 which runs substantially parallel to the base housing 102, and perpendicular to the mixing end 108, when in use. The proximal handle 110 provides another grip location, allowing the user to grip the food processing device 100 with one hand on the proximal handle 110 and another hand on the base housing 102. The mixing attachment 104 includes a curved U-shaped segment 158 extending between a mixing attachment body portion 160, which connects to the base housing 102, and the proximal handle 110. The proximal handle 110 includes a grip portion 162, which is a substantially straight section upon which the user is primarily meant to grip the proximal handle 110. The proximal handle 110 can terminate in a sloped handle end 164 which can help orient a user to the end of the proximal handle 110. Above the grip portion 162, and adjacent the U-shaped segment 158, the mixing attachment 104 includes a second user control 166.

The second user control 166 can function similarly to the first user control 132, except as otherwise shown and described herein. In particular, while the power state and motor speed of the food processing device 100 are ordinarily controlled by the first user control 132 on the base housing 102, attaching the mixing attachment 104 to the base housing 102 can automatically disable the first user control 132 (and first operational mode) and enable the second user control 166 (and second operational mode). In the second operational mode, the second user control 166 controls the power state and motor speed of the food processing device 100. This can be accomplished by including electrical contacts (e.g. electrodes, pins, pads, or the like) 155 on a base attachment area and/or attachment interface 148 of the mixing attachment 104, and corresponding electrodes and/or electrical contacts 151 on the distal end and/or attachment receiver 142 of the base housing 102. When the mixing attachment 104 and base housing 102 are attached, the electrical contacts complete an electrical connection between a base housing processor and an attachment processor which enables the processors to coordinate to switch the food processing device 100 to the second operational mode.

In one example, as best seen in FIG. 9, the second user control 166 can include a power toggle button 168 which can be actuated to switch the device 100 between an on and off state. A roller 170 can be rolled up or down to increase or decrease, respectively, the speed of the motor. The roller 170 is positioned to roll along the axial direction of the handle 110, allowing the roller 170 to be easily controlled by the thumb of a user. The second user control 166 can include indicator lights 174, or other indicia, which display a current motor speed, or other settings, to the user. The second user control 166 can also include an eject button 172, which can be actuated to release the mixing end 108.

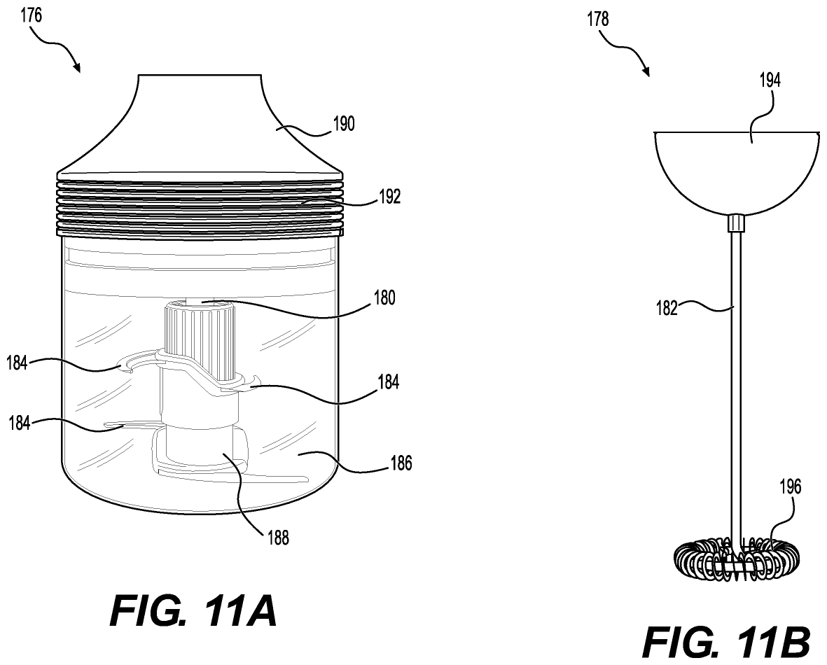

Referring now to FIGS. 11a-11b, alternative blending attachments 176, 178 are shown. The blending attachments 176, 178 can function similarly to the blending attachment 106, except as otherwise shown and described. In particular, the blending attachments 176, 178 connect to the base housing 102 axially aligned with the base housing 102, as the blending attachment 106 described above, and each include a shaft 180, 182 which is driven by the motor of the base housing 102. However, the alternative attachments are suited to serve additional food processing needs.

In particular, the blending attachment 176 includes a central rotating member 188 which includes a number of separate, vertically offset blades 184. The central rotating member 188 is surrounded by a container 186. Food can be placed within the container 186 for slicing, and the container 186 can then be sealed to an upper portion 190 of the blending attachment 176 via a threads 192. Blending attachment 176 can be used for a range of types of food processing, including chopping vegetables like onion or mirepoix, or even chopping meat. This can be advantageous when making food such as dips, like salsa and guacamole. The blending attachment 178 includes an upper housing 194 for attaching to the base housing 102, and an opposing end with a circular frother end 196. This can be particularly useful for frothing milk, with the shaft 182 being removable for easier storage and cleaning of the frothing end 196.

Referring now to FIGS. 12a-12b, alternative mixing ends 154, 156 are shown which can be attached to the mixing end attachment portion 112 of the mixing attachment 104. The alternative mixing ends 154, 156 function similarly to the mixing end 108, except as otherwise shown and described herein. In particular, the mixing end 154 is singular beater, or whisk, which can be attached centrally to the mixing end attachment portion 112. The mixing ends 156 are a set of two dough hooks, which can be used as an alternative which provides a hooked end for kneading dough.

In this way, as described above, the food processing device 100 provides a motorized base handle 100 which allows for a large number of different food processing options. A number of different blending attachments (e.g. 106, 176, 178) can be attached directly to the base housing 102 for various food processing needs. Alternatively, the mixing attachment 104 can be attached to the base housing 102, with controls 166 of the mixing attachment 104 assuming control of the processing device 100. The mixing attachment 104 allows for various different mixing ends (e.g. 108, 153, 156) to be removably attached depending on a given food processing need, allowing for even more versatility. Further, the mixing attachment 104 provides an additional handle 110 and holds the mixing ends perpendicular to both the handle 110 and the base housing 102. Therefore the device offers various attachment orientations for easier control for different applications. Additionally, the food processing device 100 is controllable by a convenient control set, the operational control set depending on the current attachment to the base housing 102.

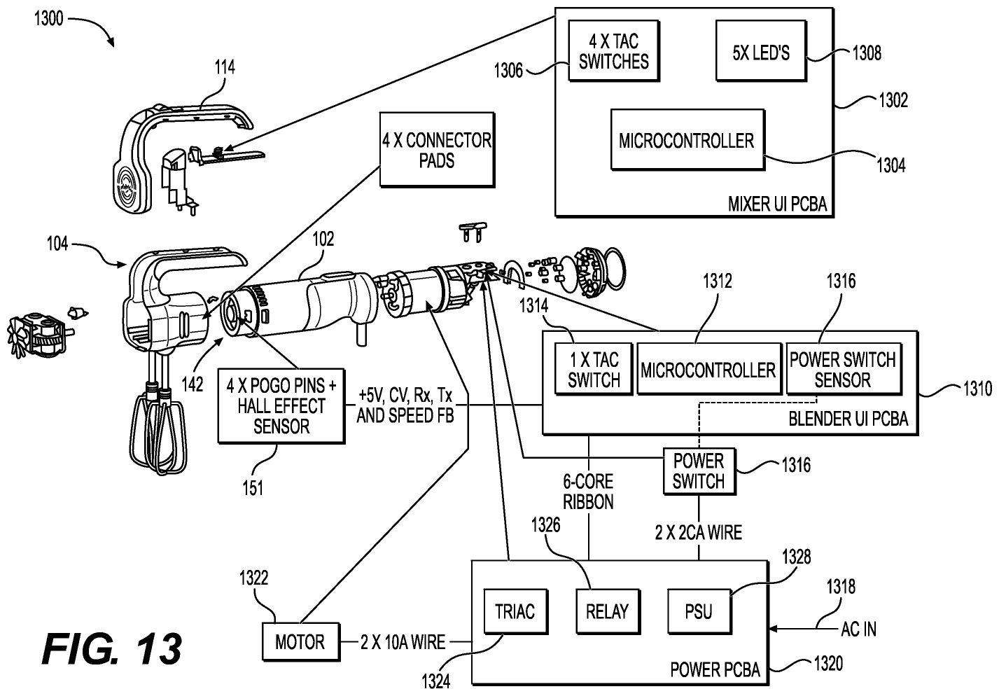

FIG. 13 includes an exploded view 1300 of food processing device 100 with functional block diagrams associated with the electronics of device 100 and mixer attachment 104. FIG. 13 illustrates that base housing 102 includes electrical contacts 151 which may be pogo type pins or electrodes while mixing attachment 104 includes corresponding and/or mating electrical contacts 155 that engage with electrical contacts 151 when mixing attachment 104 is received by base housing 102 at the attachment receiver 142. Handle 110 of mixing attachment 104 includes a printed circuit board (PCB) 1302 having attachment processor 1304, one or more user operatable switches 1306, and one or more user indicators 1308, e.g., LEDs. Base housing 102 includes base processor PCB 1310 having base processor 1312, user operable switches 1314, and power switch 1316. Base housing 102 may also include power PCB 1320 having a phase-angle adjusting triode for alternating current (TRIAC) and/or AC switch 1324, a motor control relay 1326, and power supply unit (PSU) 1328 arranged to receive an AC power input 1318.

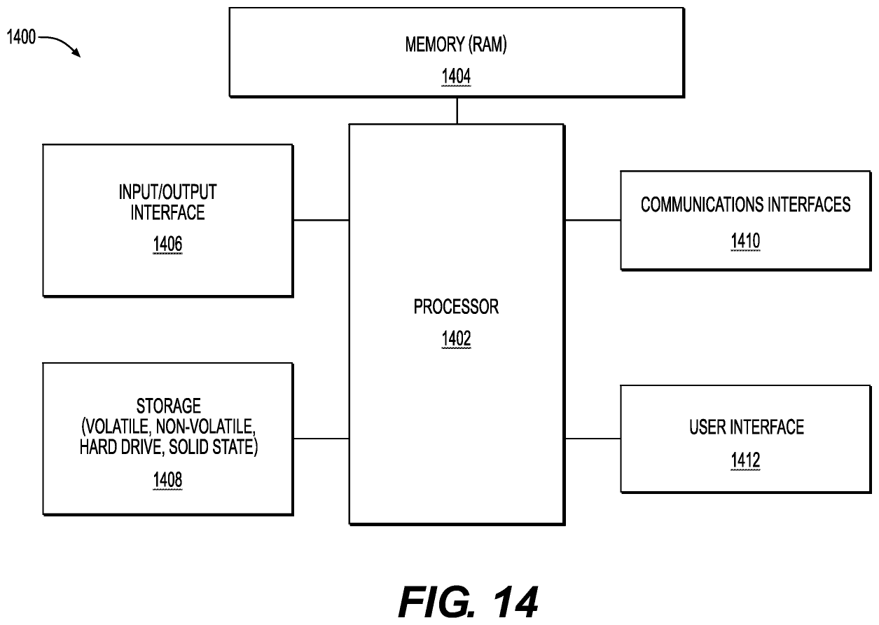

FIG. 14 is a block diagram of an illustrative computer system 1400. Computer system 1400 could represent a processing system within a device such as, for example, a food processing device, kitchen tool, a micro puree machine, a blender, an ice cream maker, an immersion blender, or an attachment to any of such devices. Computer system 1400 may include a system-on-a-chip (SoC), a client device, and/or a physical computing device and may include hardware and/or virtual processor(s). In some implementations, computer system 1400 and its elements as shown in FIG. 1400 each relate to physical hardware and in some implementations one, more, or all of the elements could be implemented using emulators or virtual machines. Regardless, computer system 1400 may be implemented on physical hardware.

As also shown in FIG. 1400, computer system 1400 may include a user interface 1412, having, for example, a keyboard, keypad, touchpad, or sensor readout (e.g., biometric scanner) and one or more output devices, such as displays, speakers for audio, LED indicators, and/or light indicators. Computer system 1400 may also include communications interfaces 1410, such as a network communication unit that could include a wired communication component and/or a wireless communications component, which may be communicatively coupled to processor 1402. The network communication unit may utilize any of a variety of proprietary or standardized network protocols, such as Ethernet, TCP/IP, to name a few of many protocols, to effect communications between processor X00 and another device, network, or system. Network communication units may also comprise one or more transceivers that utilize the Ethernet, power line communication (PLC), Wi-Fi, cellular, and/or other communication methods.

Computer system 1400 includes a processing element, such as processor 1402, that contains one or more hardware processors, where each hardware processor may have a single or multiple processor cores. In one implementation, the processor 1402 includes at least one shared cache that stores data (e.g., computing instructions) that are utilized by one or more other components of processor 1402. For example, the shared cache may be a locally cached data stored in a memory for faster access by components of the processing elements that make up processor 1402. Examples of processors include, but are not limited to a central processing unit (CPU) and/or microprocessor. Processor 1402 may utilize a computer architecture base on, without limitation, the Intel® 8051 architecture, Motorola® 68HCX, Intel® 80X86, and the like. The processor 1402 may include, without limitation, an 8-bit, 12-bit, 16-bit, 32-bit, or 64-bit architecture. Although not illustrated in FIG. 14, the processing elements that make up processor 1402 may also include one or more other types of hardware processing components, such as graphics processing units (GPUs), application specific integrated circuits (ASICs), field-programmable gate arrays (FPGAs), and/or digital signal processors (DSPs).

FIG. 14 illustrates that memory 1404 may be operatively and communicatively coupled to processor 1402. Memory 1404 may be a non-transitory medium configured to store various types of data. For example, memory 1404 may include one or more storage devices 1408 that include a non-volatile storage device and/or volatile memory. Volatile memory, such as random-access memory (RAM), can be any suitable non-permanent storage device. The non-volatile storage devices in storage 1408 may include one or more disk drives, optical drives, solid-state drives (SSDs), tape drives, flash memory, read-only memory (ROM), and/or any other type memory designed to maintain data for a duration time after a power loss or shut down operation. In certain configurations, the non-volatile storage devices 1408 may be used to store overflow data if allocated RAM is not large enough to hold all working data. The non-volatile storage devices 1408 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 1402. In one implementation, the compiling process of the software program may transform program code written in a programming language to another computer language such that the processor 1402 is able to execute the programming code. For example, the compiling process of the software program may generate an executable program that provides encoded instructions (e.g., machine code instructions) for processor 1402 to accomplish specific, non-generic, particular computing functions.

After the compiling process, the encoded instructions may be loaded as computer executable instructions or process steps to processor 1402 from storage 1408, from memory X04, and/or embedded within processor 1402 (e.g., via a cache or on-board ROM). Processor 1402 may be configured to execute the stored instructions or process steps in order to perform instructions or process steps to transform the computing device into a non-generic, particular, specially programmed machine or apparatus. Stored data, e.g., data stored by a storage device 1408, may be accessed by processor 1402 during the execution of computer executable instructions or process steps to instruct one or more components within computing system 1400 and/or other components or devices external to system 1400.

User interface 1412 can include a display, positional input device (such as a mouse, touchpad, touchscreen, or the like), keyboard, keypad, one or more buttons, or other forms of user input and output devices. The user interface components may be communicatively coupled to processor 1402. When the user interface output device is or includes a display, the display can be implemented in various ways, including by a liquid crystal display (LCD) or a cathode-ray tube (CRT) or light emitting diode (LED) display, such as an OLED display. Input/Output Interface 106 may interface with one or more sensors that detect and/or monitor environmental conditions within or surrounding system 1400. Environmental conditions may include, without limitation, magnetic field level, rotation and/or movement of a device or component, temperature, pressure, acceleration, vibration, motion, radiation level, position or the device or component, and/or the presence of a device or component. Persons of ordinary skill in the art are aware that computer system 1400 may include other components well known in the art, such as power sources and/or analog-to-digital converters, not explicitly shown in FIG. 14.

In some implementations, computing system 1400 and/or processor 1402 includes an SoC having multiple hardware components, including but not limited to:
a microcontroller, microprocessor or digital signal processor (DSP) core and/or multiprocessor SoCs (MPSoC) having more than one processor cores;
memory blocks including a selection of read-only memory (ROM), random access memory (RAM), electronically erasable programmable read-only memory (EEPROM) and flash memory;
timing sources including oscillators and phase-docked loops;
peripherals including counter-timers, real-time timers and power-on reset generators;
external interfaces, including industry standards such as universal serial bus (USB), FireWire, Ethernet, universal synchronous/asynchronous receiver/transmitter (USART), serial peripheral interface (SPI);
analog interfaces including analog-to-digital converters (ADCs) and digital-to-analog converters (DACs); and
voltage regulators and power management circuits.

A SoC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

Once the overall architecture of the SoC has been defined, individual hardware elements may be described in an abstract language called RTL which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some implementations, some or all of the components of computer system X00 are implemented on a printed circuit board (PCB). One or more features of system 1400 may be implemented within the systems and processors described with respect to FIGS. 13, 15, 16, 17, and 18.

FIG. 15 shows a block diagram 1500 of the electrical connector 1502 between a base processor 1312 in base housing 102 and attachment processor 1304 that facilitates active attachment identification of, for example, mixer attachment 104. Base processor 1312 includes multiple data ports 1504, 1506, 1508, and 1510. Data ports 1504, 1506, 1508, 1510 are electrically connected to electrical contacts 1512, 1514, 1516, and 1518 in electrical connector 1502 respectively. Attachment processor 1304 includes data ports 1520, 1522, 1524, and 1526 that are electrically connected to electrical contacts 1528, 1530, 1532, and 1534 in electrical connector 1502 respectively. Electrical connectors 1512-1518 form a first half of electrical connector 1502 while electrical connectors 1528-1534 form a second half of electrical connector 1502 when both halves are engaged with each other, which occurs when attachment interface 148 of food processing device attachment 104, e.g., the mixer attachment, is received by base housing 102 via attachment receiver 142. The electrical connectors 1512-1518 may be male type connectors, such as pogo pins, while electrical connectors 1528-1534 may be female type connectors, or visa versa.

When electrical connectors 1512-1518 are engaged with electrical connectors 1528-1534, electrical communications are established between base processor 1312 and attachment processor 1304 via, for example, data ports 1504, 1506, 1508, and 1510 with data ports 1520, 1522, 1524, and 1526 respectively. Port 1508 may be configured as a data receiver (Rx) to enable processor 1312 to receive identification information or an identification signal, control instructions, and/or status information from attachment processor 1304. An identification signal and/or identification information may include a data packet or sequence of data pulses including data bits arranged to uniquely identify a particular attachment and/or identify a type of food processing attachment, e.g., a serial number, attachment number, or model number. Port 1510 may be configured as a data transmitter (Tx) to enable processor 1312 to send motor status data and/or control instructions to attachment processor 1304. Port 1526 of attachment processor 1304 may be configured as a data receiver (Rx) to enable processor 1304 to receive control instructions and/or status information from base processor 1312. Port 1524 may be configured as a data transmitter (Tx) to enable processor 1304 to send status data and/or control instructions to base processor 1312.

In some implementations, ports 1508, 1510, 1524, and 1526 enable full duplex communications between base processor 1312 and attachment processor 1304. Communications between processors 1312 and 1304 may enable other functions such as supporting software and/or firmware updates of food processing device 100 from an attachment 104 or enable a software and/or firmware update of attachment 104 from food processing device 100. Hence, a manufacturer may be able to facilitate software and/or firmware updates of food processing devices sold to customers by propagating software/firmware updates using new and/or updated attachments subsequently obtained by users. Processor 1312 may provide a power signal, e.g., 5v, from port 1504 via electrical connector 1502 to attachment processor 1304 and/or other components in an attachment such as mixer attachment 104. In some implementations, the power signal may be provided from a power supply other than processor 1312. A ground signal, e.g., 0 v, may be provided via electrical connection 1502 from processor 1312 and/or another source to processor 1304 and/or other components in an attachment.

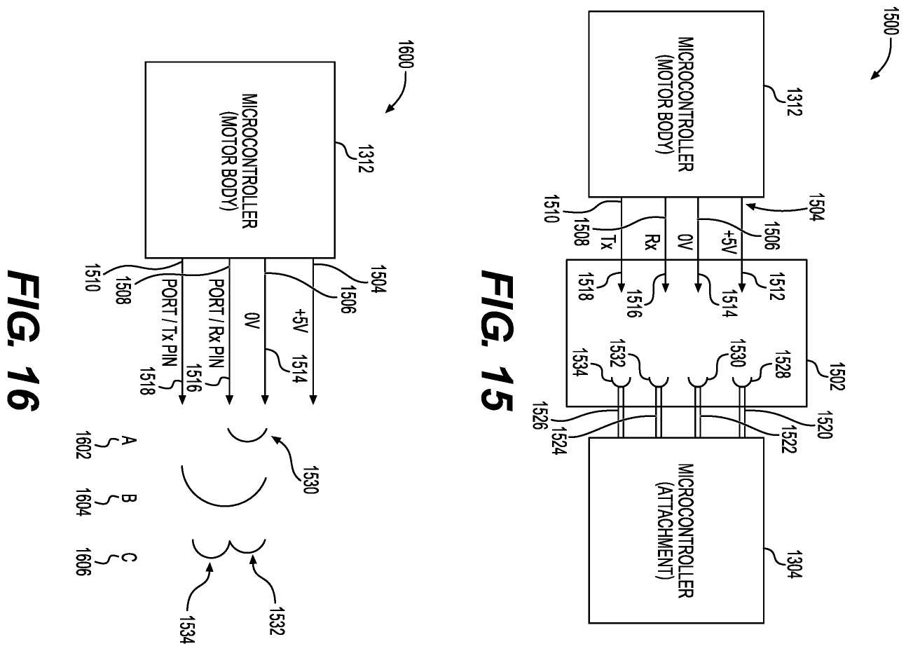

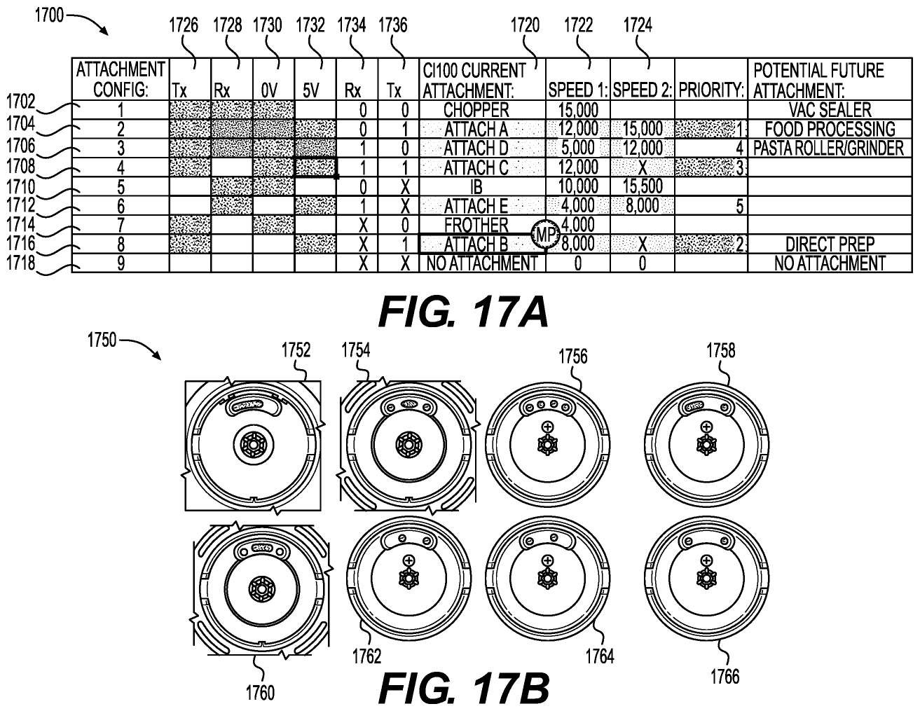

FIG. 16 shows a diagram 1600 of the electrical connections between base processor 1312 in the base housing 102 and an attachment that facilitates passive attachment identification. In this example, the attachment may not include a processor capable of communicating with processor 1312 and is, therefore, not capable of sending an attachment identification signal. Instead, the attachment may include a unique connector 1502 configuration of its electrical contacts such as contacts 1530, 1532, and 1534. For example, for attachment type A, contacts 1530 and 1532 of electrical connector 1502 may be shorted together such that base processor 1312 senses 0 v at ports 1506 and 1508 to identify the connected attachment as a type A attachment. For attachment type B, electrical contacts 1530 and 1534 may be shorted together such that base processor 1312 senses 0 v at ports 1506 and 1510 to identify the connected attachment as a type B attachment. For attachment type C, electrical contacts 1530, 1532, and 1534 may be shorted together such that base processor 1312 sense 0 v at ports 1506, 1508, and 1510 to identify the connected attachments as a type C attachment. While only connections between various contacts and 0 v are illustrated, various contact connections with the 5 v port may be implemented to facilitate identification of additional attachment types as will be discussed further in FIGS. 17A and 17B.

FIG. 17A includes a table 1700 correlating electrical contact configurations 1702-1718 with different attachment types in column 1720. Table 1700 may also include configuration data for each attachment types such as motor speeds listed in columns 1722 and 1724. Table 1700 may be stored in a memory such as storage 1408 and be accessible by processor 1312. Columns 1726-1732 show which electrical contacts are connected together in a food processing attachment to enable identification of the attachment type in column 1720. Columns 1724 and 1726 shows whether the Rx and Tx ports 1508 and 1510 of base processor 1312 are connects to 0 v, 5 v, or not connected to the attachment half of electrical connector 1502. By not making a connection, the voltage sensed at the Rx and Tx ports, e.g., ports 1508 and 1510, by base processor 1312 will not be at 0 v or 5 v and, therefore, base processor 1312 can use this third voltage level to identify additional attachments. As illustrated in table 1700, base processor 1312 is able to passively identify up to nine different attachment types. In some implementations, base processor 1312 may include internal or external biasing circuits to set a voltage level at ports 1508 and/or 1510 to an intermediate voltage between 0 v and 5 v when the ports do not have an electrical connection at electrical connector 1502. In configuration 1718 of table 1700, no ports have electrical connections at electrical connector 1502 which may indicate that there is no attachment connected to the food processing device 100.

FIG. 17B shows a set 1750 of different physical arrangements and/or electrical contact configurations 1752-1766 at the attachment interface 148 associated with the attachment types and their configurations 1702-1718 identified in table 1700 of FIG. 17A.

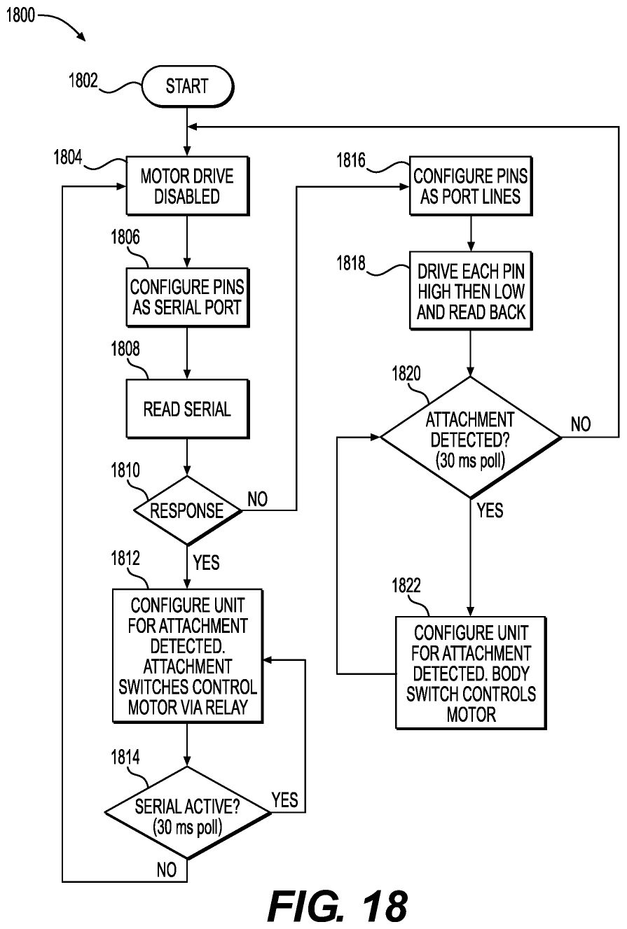

FIG. 18 includes a flow diagram of a process 1800 for detecting the connection of an attachment, e.g., attachment 104, to a food processing device 100 and operating the food processing device 100 in response. Process 1800 begins at power up and/or processor 1312 boot up (Step 1802). The motor drive for motor 1322 may be initially disabled (Step 1804). Processor 1312 initially configures ports 1508 and 1510 as serial communications ports and transmits a poll signal from Tx port 1510 to electrical contact 1518 (Step 1806). Processor 1312 may, at initial power up, and at regular intervals thereafter, transmit “polls” and/or poll signals to the food processing attachment. Processor 1312 monitors Rx port 1508 for a response from an attachment processor 1304 via electrical connector 1502 (Step 1810). If processor 1312 receives a response that includes an attachment identification signal, processor 1312 configures food processing device 100 for operations with the identified attachments type. Processor 1312 may configure and/or control motor 1322 based on the settings stored in data storage 1408. Depending on the detected attachment type, processor 1312 may transfer control of food processing device 100 to processor 1304 and/or switches 1306 in food processing attachment 104, e.g., the mixer attachment (Step 1812).

Processor 1312 may continue to monitor Rx port 1508 to detect the presence and/or operations of food processing attachment 104 (Step 1814) and, if detected, return to Step 1812. If processor 1312 does not receive a response in Step 1810, processor 1312 enters a passive attachment detection mode and configures ports 1508 and 1510 as port lines to sense voltage levels (Step 1816). Processor 1312 may drive each port line 1508 and 1510 high and low, and then sense and/or read the voltage level on each line (Step 1818). Processor 1312 then determines the voltage at ports 1508 and 1510 and identifies the connected food processing attachment according to the voltage values in columns 1734 and 1736 of table 1700 which may be stored in data storage 1408. For example, if processor 1312 reads 0 v at port 1508 and 0 v at port 1510, then processor 1312 determines that the connected attachment is a chopper. If processor 1312 reads neither 0 v nor 5 v at port 1508, i.e., no electrical connection, and reads 0 v at port 1510, then processor 1312 determines that the connected attachment is a frother (Step 1820). Once a type of food processing attachment is identified and/or detected, processor 1312 may configure and/or control motor 1322 based on the settings in columns 1722 and/or 1724 of table 1700.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

It will be apparent to those of ordinary skill in the art that certain aspects involved in the operation of food processing device 100 and an attachment such as mixer attachment 104, and their respective processors if present, may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon. While the subject technology has been described with respect to preferred embodiments, those skilled in the art will readily appreciate that various changes and/or modifications can be made to the subject technology. For example, each claim may depend from any or all claims in a multiple dependent manner even though such has not been originally claimed.

What is claimed is:

1. A food processing device comprising:
a base housing including:
an attachment receiver arranged to receive a food processing attachment configured to perform a food processing operation, the attachment receiver including an electrical connector having a plurality of electrical contacts; and
a first processor including a plurality of ports, each port of the plurality of ports being in electrical communication with each of the plurality of electrical contacts respectively;
wherein the first processor is configured to: i) receive an identification signal at a first port of the plurality of ports via the electrical connector from a second processor in the received food processing attachment to identify the received food processing attachment, and ii) when an identification signal is not received, monitor a voltage at each of the plurality of ports to identify the received food processing attachment.

2. The food processing device of claim 1, wherein the first processor is configured to periodically transmit a poll signal via the electrical connector to the received food processing attachment from a second port of the plurality of ports.

3. The food processing device of claim 2, wherein the identification signal is received by the first processor via the electrical connector in response to transmitting the poll signal.

4. The food processing device of claim 1, wherein the base housing is configured to provide a power signal to the food processing attachment via the electrical connector.

5. The food processing device of claim 4, wherein the base housing is configured to provide a ground connection to the food processing attachment via the electrical connector.

6. The food processing device of claim 1, wherein the identification signal includes an identity of the type of food processing attachment.

7. The food processing device of claim 1, wherein the type of attachment includes one of a blender, chopper, mixer, immersion blender, frother, vacuum sealer, pasta roller, grinder, food processor, and direct prepper.

8. The food processing device of claim 1, wherein the identification signal is received via asynchronous serial communications.

9. The food processing device of claim 1, wherein the first processor is configured to receive a motor control signal at the first port via the electrical connector from the second processor.

10. The food processing device of claim 1, wherein the first processor is configured to transmit motor status data to the second processor via the electrical connector from the second port of the plurality of ports.

11. A food processing attachment for a food processing device comprising:
an attachment interface arranged to detachably connect to an attachment receiver in a base housing of the food processing device, the attachment interface including an electrical connector having a plurality of electrical contacts; and
an attachment processor including a plurality of ports, each port of the plurality of ports being in electrical communication with each of the plurality of electrical contacts respectively;
wherein the attachment processor is configured to transmit an identification signal from a first port of the plurality of ports of the attachment processor to a base processor in the base housing of the food processing device via the electrical connector when the attachment interface is connected to the attachment receiver.

12. The food processing attachment of claim 11, wherein the attachment processor is configured to receive a poll signal at a second port of the plurality of ports from the base processor via the electrical connector.

13. The food processing attachment of claim 12, wherein the attachment processor transmits the identification signal in response to receiving the poll signal.

14. The food processing attachment of claim 13, wherein the food processing attachment is configured to receive a power signal from the base housing via the electrical connector.

15. The food processing attachment of claim 14, wherein the food processing attachment is configured to receive a ground connection from the base housing via the electrical connector.

16. The food processing attachment of claim 15, wherein the identification signal includes an identity of the type of food processing attachment.

17. The food processing attachment of claim 11, wherein the identification signal is transmitted via asynchronous serial communications.

18. The food processing attachment of claim 11, wherein the attachment processor is configured to transmit a motor control signal to control a motor in the base housing via the electrical connector.

19. The food processing attachment of claim 11, wherein the attachment processor is configured to receiver motor status data from the base processor via the electrical connector.

20. A method for identifying a food processing attachment comprising:
connecting the food processing attachment to a base housing of a food processing device via an attachment receiver including an electrical connector have a plurality of electrical contacts;
electrically connecting each of a plurality of ports of a first processor in the base housing with each of a plurality of electrical contacts respectively;
receiving, by the first processor, an identification signal at a first port of the plurality of ports via the electrical connector from a second processor in the received food processing attachment to identify the received food processing attachment; and
when an identification signal is not received, monitoring by the first processor a voltage at each of the plurality of ports to identify the received food processing attachment.
